(19) United States
(12) Patent Application Publication
(10) Pub. No.: US 2026/0244210 A1
(43) Pub. Date: Aug. 20, 2026

(54) OPERATION PATH ADJUSTMENT METHOD AND APPARATUS, STORAGE MEDIUM, AND POOL ROBOT

(71) Applicant: XINGMAI INNOVATION TECHNOLOGY (SUZHOU) CO., LTD., Suzhou (CN)

(72) Inventor: Shilei ZHANG, Suzhou (CN)

(73) Assignee: XINGMAI INNOVATION TECHNOLOGY (SUZHOU) CO., LTD., Suzhou (CN)

(21) Appl. No.: 19/641,535

(22) Filed: Apr. 8, 2026

Related U.S. Application Data
(63) Continuation of application No. PCT/CN2023/136537, filed on Dec. 5, 2023.

(30) Foreign Application Priority Data
Oct. 8, 2023 (CN) 202311294133X

(51) Int. Cl. G05D 1/622; E04H 4/16; G01S 17/93; G05D 107/00

(52) U.S. Cl. CPC G05D 1/622; E04H 4/1654; G01S 17/93; G05D 2107/29

(57) ABSTRACT

Embodiments of this application provide an operation path adjustment method and apparatus, a storage medium, and a pool robot. The method includes: obtaining, in a process in which a pool robot moves in a target water region along a preset path, point cloud data by using a line laser assembly, where the line laser assembly is provided on the pool robot; determining obstacle information of an obstacle when it is determined, based on the point cloud data, that there is the obstacle in the target water region, where the obstacle information includes position information and posture information of the obstacle, and the obstacle obstructs a movement of the pool robot; and adjusting an operation path of the pool robot based on the obstacle information.

The present disclosure is a continuation of prior International Patent Application No. PCT/CN2023/136537, filed on December 5, 2023, which claims priority to Chinese Patent Application No. 202311294133.X, filed with the China National Intellectual Property Administration on October 8, 2023, and entitled "OPERATION PATH ADJUSTMENT METHOD AND APPARATUS, STORAGE MEDIUM, AND POOL ROBOT", which is incorporated herein by reference in its entirety.

### CROSS-REFERENCE TO RELATED APPLICATION

### TECHNICAL FIELD

Embodiments of this application relate to the field of robots, and specifically, to an operation path adjustment method and apparatus, a storage medium, and a pool robot.

### BACKGROUND

Motion paths of most related robots in a pool (for example, a cleaning robot in the pool) are irregular. Consequently, the robots are easily affected by an obstacle in water during operation and cannot accurately determine information of the obstacle and effectively avoid the obstacle, leading to low operation efficiency.

An effective solution to resolve the above technical problem in the related technology has not been proposed.

### SUMMARY

Embodiments of this application provide an operation path adjustment method and apparatus, a storage medium, and a pool robot, to at least resolve a problem in a related technology that a pool robot is easily affected by an obstacle in water, leading to low operation efficiency.

According to an embodiment of this application, an operation path adjustment method is provided. The method includes: determining, in a process in which a pool robot moves in a target water region, point cloud data obtained by using a line laser assembly, where the line laser assembly is provided on the pool robot; determining obstacle information of an obstacle when it is determined, based on the point cloud data, that there is the obstacle in the target water region, where the obstacle information includes position information and posture information of the obstacle, and the obstacle obstructs a movement of the pool robot; and adjusting an operation path of the pool robot based on the obstacle information.

According to another embodiment of this application, an operation path adjustment apparatus is provided. The apparatus includes: a first determination structure configured to determine, in a process in which a pool robot moves in a target water region, point cloud data obtained by using a line laser assembly, where the line laser assembly is provided on the pool robot; a second determination structure configured to determine obstacle information of an obstacle when it is determined, based on the point cloud data, that there is the obstacle in the target water region, where the obstacle information includes position information and posture information of the obstacle, and the obstacle obstructs a movement of the pool robot; and a first adjustment structure configured to adjust an operation path of the pool robot based on the obstacle information.

According to still another embodiment of this application, a computer-readable storage medium is further provided. The computer-readable storage medium stores a computer program. When the computer program is run, steps in any one of the method embodiments are performed.

According to still another embodiment of this application, a pool robot is further provided. The pool robot includes a memory and a processor. The memory stores a computer program. The processor is configured to: when executing the computer program, perform steps in any one of the method embodiments.

According to this application, in a moving process of the pool robot, the point cloud data is obtained by using the line laser assembly provided on the pool robot, so that the obstacle information can be accurately determined based on the point cloud data. Therefore, the operation path of the pool robot can be flexibly adjusted based on the obstacle information. In this way, operation efficiency of the pool robot is not affected by the obstacle.

### BRIEF DESCRIPTION OF THE DRAWINGS

FIG. 1 is a block diagram of a hardware structure of a mobile terminal for performing an operation path adjustment method according to an embodiment of this application;

FIG. 2 is a flowchart of an operation path adjustment method according to an embodiment of this application;

FIG. 3 is a schematic diagram of a line laser sensor provided on a cleaning robot according to an embodiment of this application; and

FIG. 4 is a block diagram of a structure of an operation path adjustment apparatus according to an embodiment of this application.

### DETAILED DESCRIPTION OF THE EMBODIMENTS

Embodiments of this application are described in detail in the following with reference to the accompanying drawings.

It should be noted that in this specification, claims, and the accompanying drawings of this application, the terms "first", "second", and the like are intended to distinguish between similar objects but do not necessarily indicate a specific order or sequence.

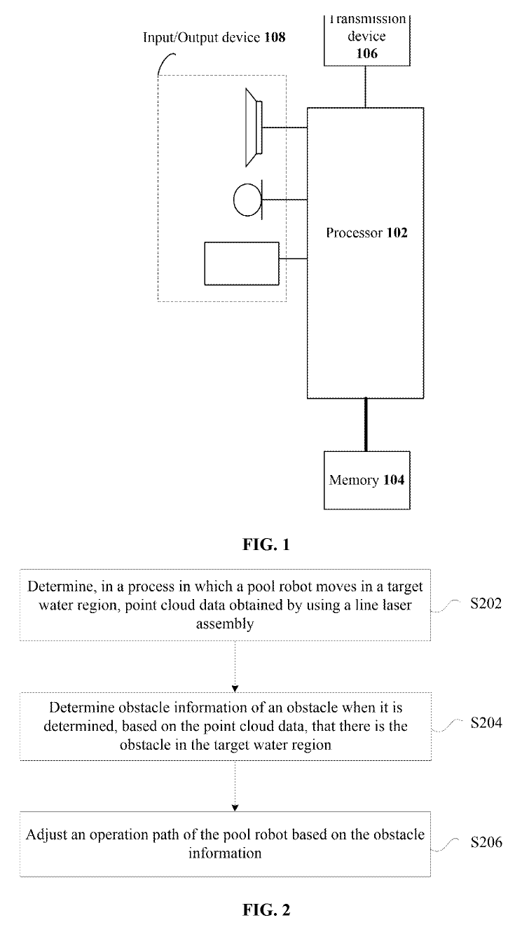

The method provided in embodiments of this application may be performed by a mobile terminal, a computer terminal, or a similar computing apparatus. An example in which the method is performed by the mobile terminal is used. FIG. 1 is a block diagram of a hardware structure of a mobile terminal for performing an operation path adjustment method according to an embodiment of this application. As shown in FIG. 1, the mobile terminal may include one or more (only one processor is shown in FIG. 1) processors 102 (the processor 102 may include, but is not limited to, a processing apparatus such as a microprocessor unit MPU or a field-programmable gate array FPGA) and a memory 104 configured to store data. The mobile terminal may further include a transmission device 106 with a communication function and an input/output device 108. A person skilled in the art may understand that the structure shown in FIG. 1 is only an example and does not constitute any limitation on the structure of the mobile terminal. For example, the mobile terminal may alternatively include more or fewer components than those shown in FIG. 1 or have a configuration different from that shown in FIG. 1.

The memory 104 may be configured to store a computer program, for example, a software program of application software and modules, for example, a computer program corresponding to the operation path adjustment method in embodiments of this application. The processor 102 executes the computer program stored in the memory 104 to execute various functional applications and data processing, that is, to implement the above method. The memory 104 may include a high-speed random access memory or a non-volatile memory, for example, one or more magnetic storage apparatuses, a flash memory, or another non-volatile solid-state memory. In some examples, the memory 104 may further include memories that are remotely disposed relative to the processor 102, and these remote memories may be connected to the mobile terminal through a network. Examples of the foregoing network include, but are not limited to, the Internet, an intranet, a local area network, a mobile communication network, and a combination thereof.

The transmission device 106 is configured to receive or send data through a network. Specific examples of the network may include a wireless network provided by a communication provider of the mobile terminal. In one example, the transmission device 106 includes a network interface controller (Network Interface Controller, NIC) and may be connected to other network devices through a base station to communicate with the Internet. In one example, the transmission device 106 may be a radio frequency (Radio Frequency, RF) module configured to communicate with the Internet in a wireless manner.

An embodiment provides an operation path adjustment method. FIG. 2 is a flowchart of an operation path adjustment method according to an embodiment of this application. As shown in FIG. 2, the method includes the following steps.

Step S202: Determine, in a process in which a pool robot moves in a target water region, point cloud data obtained by using a line laser assembly, where the line laser assembly is provided on the pool robot.

Step S204: Determine obstacle information of an obstacle when it is determined, based on the point cloud data, that there is the obstacle in the target water region, where the obstacle information includes position information and posture information of the obstacle, and the obstacle obstructs a movement of the pool robot.

Step S206: Adjust an operation path of the pool robot based on the obstacle information.

The above steps may be performed by a terminal, a server, a specific processor of the terminal or the server, a processor or a processing device provided independently of the terminal or the server, or the pool robot. However, this is not limited thereto.

Optionally, the operation path adjustment method may be applied to, but is not limited to, a scenario in which the pool robot moves in a water region or a scenario in which the pool robot is controlled to move in a specific place along a target path.

Optionally, the pool robot may include, but is not limited to, an automatic moving device, for example, a cleaning robot configured to clean a pool or a disinfection robot configured to disinfect a pool. The line laser assembly includes, but is not limited to, a single-line laser sensor, a dual-line laser sensor, a vision sensor, and the like. For example, when the line laser assembly is a dual-line laser sensor, the dual-line laser sensor may be provided at any position on the pool robot, for example, on a left side, a right side, or a front side or a rear side of the pool robot in an operation direction. Optionally, FIG. 3 is a schematic diagram of a line laser sensor provided on a cleaning robot according to an embodiment of this application. As shown in FIG. 3, a vertical dual-line laser sensor is provided in the middle of a head portion of the pool robot to obtain information in different height directions, thereby maximally obtaining the point cloud data of the obstacle.

It should be noted that because the pool robot moves in the target water region, the line laser assembly may be a highly waterproof line laser sensor, a highly waterproof lidar, or the like.

Optionally, the obstacle includes, but is not limited to, an obstacle in a cleaning region of the pool robot, for example, a wall in a swimming pool. The position information of the obstacle includes three-dimensional coordinates of the obstacle scanned by the line laser assembly. The posture information of the obstacle includes a shape, a size, a type, and the like of the obstacle. The operation path of the pool robot may be a preset path, for example, a path for performing cleaning along an edge, a path for climbing a wall and performing cleaning, or a bow-shaped cleaning path (the bow-shaped path means that two adjacent paths are parallel to each other, and the pool robot moves along the two adjacent paths in two opposite forward directions). In addition, the pool robot may perform cleaning and disinfection in the moving process in the target water region or cruise.

According to the above steps, in a moving process of the pool robot, the point cloud data is obtained by using the line laser assembly provided on the pool robot, so that the obstacle information can be accurately determined based on the point cloud data. Therefore, the operation path of the pool robot can be flexibly adjusted based on the obstacle information. In this way, operation efficiency of the pool robot is not affected by the obstacle. Therefore, a problem in a related technology that a pool robot is easily affected by an obstacle in water, leading to low operation efficiency can be resolved. In this way, the operation efficiency of the pool robot in water can be improved.

In an example embodiment, when the line laser assembly includes a dual-line laser assembly, the determining, in a process in which a pool robot moves in a target water region, point cloud data obtained by using a line laser assembly includes: in the process in which the pool robot moves in the target water region, obtaining the point cloud data by using the dual-line laser assembly. The dual-line laser assembly includes two line laser sensors. In this embodiment, the plurality of laser sensors included in the dual-line laser assembly may be laterally provided on at least one of the left side, the right side, the front side, or the rear side of the pool robot or may be vertically provided on the pool robot. A direction of a point cloud obtained laterally and a direction of a point cloud obtained vertically are different. Optionally, in this embodiment, point cloud data in a height direction may be obtained by using the dual-line laser assembly. This helps precisely determine the obstacle information.

In an example embodiment, the determining obstacle information of an obstacle when it is determined, based on the point cloud data, that there is the obstacle in the target water region includes: converting the point cloud data from a robot coordinate system to a world coordinate system to obtain three-dimensional coordinates of each piece of point data in the point cloud data in the world coordinate system; and determining the position information and the posture information of the obstacle based on the three-dimensional coordinates of each piece of point data in the world coordinate system. In this embodiment, coordinates of a point included in the point cloud data scanned by the line laser assembly are coordinates in the robot coordinate system. The coordinates are converted from the robot coordinate system to the world coordinate system, so that three-dimensional coordinates of each point in the world coordinate system can be obtained. In the world coordinate system, a contour of the obstacle, a posture of the obstacle, and a position of the obstacle relative to the robot coordinate system can be clearly marked.

Optionally, the determining the position information and the posture information of the obstacle based on the three-dimensional coordinates of each piece of point data in the world coordinate system includes: connecting three-dimensional coordinates of adjacent pieces of point data in a plurality of pieces of point data in the world coordinate system based on the three-dimensional coordinates of each piece of point data to obtain a connection relationship between the plurality of pieces of point data; determining a contour of the obstacle based on the connection relationship; and determining the position information and the posture information of the obstacle based on the contour of the obstacle. In this embodiment, the contour of the obstacle includes the three-dimensional coordinates of each piece of point data of the obstacle, and a specific position of the obstacle can be determined based on the three-dimensional coordinates of the plurality of pieces of point data. The plurality of adjacent pieces of point data are connected, so that the contour, a size, a position, and a shape of the obstacle can be determined based on the connection relationship. In this way, the obstacle can be accurately constructed, and a selected operation path can be determined based on the obstacle information. This improves the operation efficiency of the pool robot.

In an example embodiment, the adjusting an operation path of the pool robot based on the obstacle information includes: projecting three-dimensional coordinates of each piece of point data corresponding to the obstacle onto a corresponding grid cell of a grid map to determine a position of the obstacle on the grid map, where the grid map is a pre-constructed map of the target water region; updating the grid map based on the position of the obstacle on the grid map and the posture information of the obstacle to obtain a target grid map; and adjusting the operation path of the pool robot based on the target grid map. In this embodiment, the grid map may be a map pre-constructed based on collected laser point cloud data, and the grid map includes a plurality of grid cells of preset sizes (for example, 1 cm). The plurality of grid cells include a grid cell marked as the obstacle and a blank grid cell. Certainly, all grid cells of the entire grid map may alternatively be blank grid cells. Projecting each point onto a corresponding grid cell means marking an obstacle by using the grid cell. Optionally, a position and a posture of the obstacle on the grid map are marked in a corresponding grid cell of the grid map to replace an original mark in the grid cell, so that the grid map is updated.

It should be noted that because one obstacle includes a plurality of pieces of point data, and the plurality of pieces of point data may be all projected onto a same grid cell, the plurality of pieces of point data marked in the same grid cell need to be processed. Optionally, the projecting three-dimensional coordinates of each piece of point data in the point cloud data onto a corresponding grid cell of a grid map to determine a position of the obstacle on the grid map includes: filtering, when a plurality of pieces of point data in the point cloud data are projected onto a same grid cell of the grid map, the plurality of pieces of point data projected onto the same grid cell to ensure that one piece of point data is projected onto one grid cell; and determining a position of the grid cell onto which the point data is projected as the position of the obstacle on the grid map. In this embodiment, the filtering the plurality of pieces of point data includes retaining one piece of point data and deleting the other pieces of point data. For example, when the point cloud data includes ten coordinate points, if five coordinate points are all projected onto a same grid cell, only one coordinate point is retained in the grid cell, and the other four are deleted. Alternatively, the plurality of pieces of point data may be combined into one piece of point data. In this way, the obstacle can be marked concisely, an amount of data stored in the grid cell can be reduced, and data storage efficiency can be improved.

Optionally, the adjusting the operation path of the pool robot based on the target grid map includes: in a process in which the pool robot moves in the target water region along a preset path, detecting whether there is a target obstacle with a preset distance of the pool robot on the target grid map, where the target obstacle is any obstacle in a plurality of obstacles marked on the target grid map; and adjusting the preset path when there is the target obstacle within the preset distance, so that the pool robot operates along an adjusted preset path. In this embodiment, the preset distance may be set based on an actual scenario. For example, whether there is an obstacle within 50 cm around the pool robot is detected on the grid map. The preset path may be a default motion path of the pool robot, for example, a path for moving along an edge. The preset path may be a set operation path, for example, a path for climbing a wall and performing cleaning or a path for cleaning a step. Optionally, the adjusting the preset path, so that the pool robot operates along an adjusted preset path includes, but is not limited to, the following usage scenarios: when the pool robot moves along an edge, if it is detected that there is an obstacle on the right front of the pool robot, the pool robot is switched from moving straight to moving forward to the left to avoid the target obstacle; when the pool robot moves along an edge, if it is detected that there is a wall in front of the pool robot, the pool robot makes a quarter turn to avoid the wall; when the pool robot performs a bow-shaped movement, if it is detected that there is an obstacle in front of the pool robot, the pool robot automatically adjusts a motion path to avoid the obstacle, thereby avoiding becoming trapped; when the pool robot climbs a wall, if it is detected that there is an obstacle in a moving direction, the pool robot can adjust a motion path to bypass the obstacle and reach a target point, thereby preventing the pool robot from being trapped by the obstacle on the wall; and when the pool robot climbs a wall, if it is detected that there is a step, a strategy different from a conventional wall climbing strategy may be used to improve the operation efficiency. For instance, if the pool robot identifies a to-be-cleaned wall as a step before climbing the wall, a cleaning strategy is changed, and the pool robot can first clean a side surface of a first step and then clean a top surface of the first step.

In addition, due to constant fluctuations of water in a water region, the obstacle may move. In this embodiment, in a moving process of the pool robot, the pool robot needs to obtain the point cloud data of the obstacle in real time by using the line laser assembly and updates and marks the point cloud data to the grid map in real time, so that the pool robot can perform obstacle avoidance based on the grid map updated in real time. This improves operation execution efficiency in the water region.

Based on the foregoing descriptions of the implementations, a person skilled in the art may clearly understand that the method in the above embodiments may be implemented by software in addition to a necessary universal hardware platform or by hardware only. In many cases, the former is a preferred implementation. Based on such understanding, the technical solutions of this application can be essentially or the part that contributes to the related technology can be embodied in a form of a software product. This computer software product is stored in a storage medium (for example, a ROM/RAM, a magnetic disk, or a compact disc), and includes several instructions for instructing a terminal device (which may be a mobile phone, a computer, a server, or a network device) to perform the method described in embodiments of this application.

An embodiment of this application further provides an operation path adjustment apparatus. The apparatus is configured to implement the above embodiments and optional implementations. Some that have been described are not described in detail again. The term "module" used below may be a combination of software and/or hardware that implements a preset function. Although the apparatus described in the following embodiment is preferably implemented in software, it may be conceived that the apparatus is implemented in hardware or a combination of software and hardware.

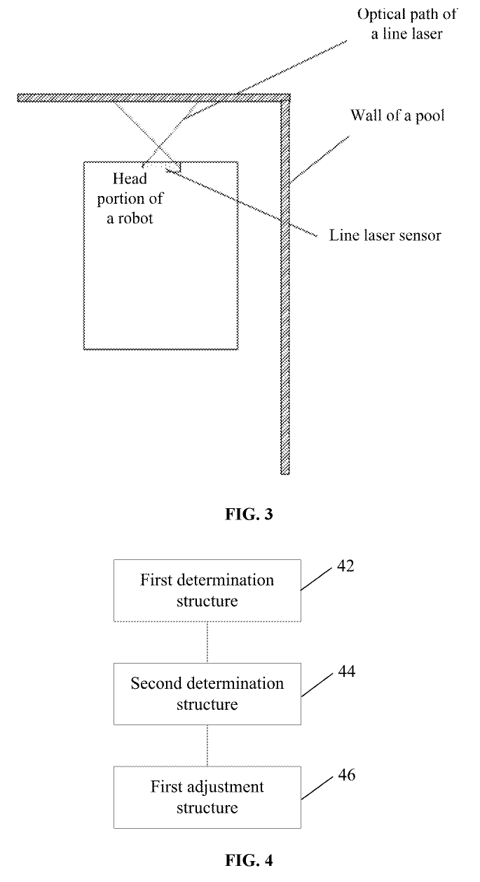

FIG. 4 is a block diagram of a structure of an operation path adjustment apparatus according to an embodiment of this application. As shown in FIG. 4, the apparatus includes: a first determination structure 42 configured to determine, in a process in which a pool robot moves in a target water region, point cloud data obtained by using a line laser assembly, where the line laser assembly is provided on the pool robot; a second determination structure 44 configured to determine obstacle information of an obstacle when it is determined, based on the point cloud data, that there is the obstacle in the target water region, where the obstacle information includes position information and posture information of the obstacle, and the obstacle obstructs a movement of the pool robot; and a first adjustment structure 46 configured to adjust an operation path of the pool robot based on the obstacle information.

In an example embodiment, the first determination structure includes a first obtaining unit configured to in the process in which the pool robot moves in the target water region, obtain the point cloud data by using a dual-line laser assembly, where the dual-line laser assembly includes two line laser sensors.

In one example embodiment, when the dual-line laser assembly is vertically provided on the pool robot, the dual-line laser assembly is capable of obtaining point cloud data of the pool robot in a height direction of the target water region.

In one example embodiment, the position information of the obstacle includes three-dimensional coordinates of the obstacle scanned by the line laser assembly.

In an example embodiment, the second determination structure includes: a first conversion unit configured to convert the point cloud data from a robot coordinate system to a world coordinate system to obtain three-dimensional coordinates of each piece of point data in the point cloud data in the world coordinate system; and a first determination unit configured to determine the position information and the posture information of the obstacle based on the three-dimensional coordinates of each piece of point data in the world coordinate system.

In an example embodiment, the first determination unit includes: a first connection sub-unit configured to connect three-dimensional coordinates of adjacent pieces of point data in a plurality of pieces of point data in the world coordinate system based on the three-dimensional coordinates of each piece of point data to obtain a connection relationship between the plurality of pieces of point data; a first determining sub-unit configured to determine a contour of the obstacle based on the connection relationship; and a second determining sub-unit configured to determine the position information and the posture information of the obstacle based on the contour of the obstacle.

In an example embodiment, the apparatus is further configured to determine the position information of the obstacle based on the three-dimensional coordinates of the plurality of pieces of point data when the contour of the obstacle includes the three-dimensional coordinates of each piece of point data of the obstacle.

In an example embodiment, the first adjustment structure includes: a first projection unit configured to project three-dimensional coordinates of each piece of point data corresponding to the obstacle onto a corresponding grid cell of a grid map to determine a position of the obstacle on the grid map, where the grid map is a pre-constructed map of the target water region; a first update unit configured to update the grid map based on the position of the obstacle on the grid map and the posture information of the obstacle to obtain a target grid map; and a first adjustment unit configured to adjust the operation path of the pool robot based on the target grid map.

In an example embodiment, the grid map is a map pre-constructed based on collected laser point cloud data, and the grid map includes a plurality of grid cells of preset sizes. The plurality of grid cells include a grid cell marked as the obstacle and a blank grid cell, or all grid cells of the entire grid map are blank grid cells.

In an example embodiment, the first projection unit includes: a first filtering sub-unit configured to filter, when a plurality of pieces of point data in the point cloud data are projected onto a same grid cell of the grid map, the plurality of pieces of point data projected onto the same grid cell to ensure that one piece of point data is projected onto one grid cell; and a second determining sub-unit configured to determine a position of the grid cell onto which the point data is projected as the position of the obstacle on the grid map.

In an example embodiment, the first filtering sub-unit is further configured to retain one piece of point data in the plurality of pieces of point data projected onto the same grid cell and delete the other pieces of point data; or combine the plurality of pieces of point data projected onto the same grid cell into one piece of point data.

In an example embodiment, the first adjustment unit includes: a first detection sub-unit configured to in a process in which the pool robot moves in the target water region along a preset path, detect whether there is a target obstacle with a preset distance of the pool robot on the target grid map, where the target obstacle is any obstacle in a plurality of obstacles marked on the target grid map; and a first adjustment sub-unit configured to adjust the preset path when there is the target obstacle within the preset distance, so that the pool robot operates along an adjusted preset path.

In an example embodiment, the first adjustment sub-unit is further configured to perform one of the following: when the pool robot operates along an edge in the target water region, if there is the target obstacle within the preset distance, adjusting the preset path along which the pool robot operates along the edge; when the pool robot performs a bow-shaped movement in the target water region, if there is the target obstacle within the preset distance, controlling the pool robot to automatically adjust the preset path along which the pool robot performs the bow-shaped movement; and when the pool robot climbs a wall in the target water region, if there is the target obstacle within the preset distance, controlling the pool robot to adjust the preset path along which the pool robot climbs the wall.

In an example embodiment, the apparatus is further configured to when the pool robot detects a step in a process of climbing a wall in the target water region, control the pool robot to change a cleaning strategy. The cleaning strategy includes first cleaning a side surface of a first step and then cleaning a top surface of the first step.

In an example embodiment, the apparatus is further configured to in the process in which the pool robot moves in the target water region, obtain the point cloud data in real time by using the line laser assembly and mark the point cloud data to the grid map in real time.

In an example embodiment, the line laser assembly is a waterproof line laser sensor or a waterproof lidar.

It should be noted that each module may be implemented by software or hardware, and for the latter, it may be implemented in the following manner: All modules are located in a same processor, or various modules are located in different processors respectively in a form of any combination. However, this is not limited thereto.

An embodiment of this application further provides a computer-readable storage medium. The computer-readable storage medium stores a computer program. When the computer program is run, steps in any one of the method embodiments are performed.

In some embodiments, the computer-readable storage medium may include, but is not limited to, any medium that can store the computer program, for example, a USB flash drive, a read-only memory (Read-Only Memory, ROM), a random access memory (Random Access Memory, RAM), a removable hard disk, a magnetic disk, or a compact disc.

An embodiment of this application further provides a pool robot. The pool robot includes a memory and a processor. The memory stores a computer program. The processor is configured to: when executing the computer program, perform steps in any one of the method embodiments.

In some embodiments, the pool robot may further include a transmission device and an input/output device. The transmission device is connected to the processor, and the input/output device is connected to the processor.

For details of specific examples in this embodiment, refer to the examples described in the above embodiments and example implementations. Details are not described in this embodiment again.

It is clear that a person skilled in the art should understand that the modules or steps in this application may be implemented by a general-purpose computing apparatus, and the modules may be integrated on a single computing apparatus or distributed on a network including a plurality of computing apparatuses, or may be implemented by program code executed by a computing apparatus. In this way, the program code can be stored in a storage apparatus and executed by the computing apparatus. In addition, in some cases, the shown or described steps may be performed in an order different from the above order, or the modules are respectively manufactured into various integrated circuit modules, or a plurality of modules are manufactured into a single integrated circuit module. In this way, this application is not limited to any particular combination of hardware and software.

The foregoing descriptions are merely preferred embodiments of this application, and are not intended to limit this application. For a person skilled in the art, this application may have various modifications and variations. Any modification, equivalent replacement, improvement, or the like made without departing from the principle of this application shall fall within the protection scope of this application.

What is claimed is:

1. An operation path adjustment method, comprising:
obtaining, in a process in which a pool robot moves in a target water region along a preset path, point cloud data by using a line laser assembly, wherein the line laser assembly is provided on the pool robot;
determining obstacle information of an obstacle when it is determined, based on the point cloud data, that there is the obstacle in the target water region, wherein the obstacle obstructs a movement of the pool robot; and
adjusting the preset path of the pool robot based on the obstacle information, so that the pool robot moves along an adjusted preset path.

2. The method according to claim 1, wherein the obstacle information comprises position information and posture information of the obstacle.

3. The method according to claim 1, wherein the obstacle information comprises contour information of the obstacle.

4. The method according to claim 1, wherein when the line laser assembly comprises a dual-line laser assembly, the obtaining, in a process in which a pool robot moves in a target water region along a preset path, point cloud data obtained by using a line laser assembly comprises in the process in which the pool robot moves in the target water region, obtaining the point cloud data by using the dual-line laser assembly, wherein the dual-line laser assembly comprises two line laser sensors.

5. The method according to claim 4, wherein when the dual-line laser assembly is vertically provided on the pool robot, the dual-line laser assembly is capable of obtaining point cloud data of the pool robot in a height direction of the target water region.

6. The method according to claim 1, wherein the line laser assembly comprises a dual-line laser assembly, wherein the dual-line laser assembly is provided on a left side, a right side, a front side, or a rear side of the pool robot in a moving direction.

7. The method according to claim 3, wherein the contour information of the obstacle comprises three-dimensional coordinates of each piece of point data of the obstacle, wherein position information of the obstacle is determined based on the three-dimensional coordinates of each piece of point data of the obstacle.

8. The method according to claim 1, wherein the adjusting the preset path of the pool robot based on the obstacle information comprises adjusting the preset path when there is the obstacle within a preset distance, so that the pool robot moves along the adjusted preset path.

9. The method according to claim 8, wherein the adjusting the preset path when there is a target obstacle within a preset distance comprises one of the following:
when the pool robot operates along an edge in the target water region, if there is the target obstacle within the preset distance, adjusting the preset path along which the pool robot operates along the edge;
when the pool robot performs a bow-shaped movement in the target water region, if there is the target obstacle within the preset distance, controlling the pool robot to automatically adjust the preset path along which the pool robot performs the bow-shaped movement; and
when the pool robot climbs a wall in the target water region, if there is the target obstacle within the preset distance, controlling the pool robot to adjust the preset path along which the pool robot climbs the wall.

10. The method according to claim 1, further comprising:
when the pool robot detects a step in a process of climbing a wall in the target water region, controlling the pool robot to change a cleaning strategy, wherein the cleaning strategy comprises first cleaning a side surface of a first step and then cleaning a top surface of the first step.

11. The method according to claim 1, wherein the obtaining, in a process in which a pool robot moves in a target water region along a preset path, point cloud data by using a line laser assembly comprises obtaining the point cloud data in real time by using the line laser assembly and updating and marking the point cloud data to a grid map in real time.

12. The method according to claim 1, wherein the line laser assembly is a waterproof line laser sensor or a waterproof lidar.

13. The method according to claim 1, wherein movement of the pool robot along the preset path comprises: the pool robot moves along an edge, performs a bow-shaped movement, or climbs a wall.

14. An operation path adjustment apparatus, comprising:
a first structure configured to obtain, in a process in which a pool robot moves in a target water region along a preset path, point cloud data by using a line laser assembly, wherein the line laser assembly is provided on the pool robot;
a second structure configured to determine obstacle information of an obstacle when it is determined, based on the point cloud data, that there is the obstacle in the target water region, wherein the obstacle obstructs a movement of the pool robot; and
a first adjustment structure configured to adjust an operation path of the pool robot based on the obstacle information.

15. The apparatus according to claim 14, wherein the obstacle information comprises position information and posture information of the obstacle.

16. The apparatus according to claim 14, wherein the obstacle information comprises contour information of the obstacle.

17. A computer-readable storage medium, wherein the computer-readable storage medium stores a computer program, and when the computer program is executed by a processor, steps of the method according to claim 1 are implemented.

18. A pool robot, comprising a memory, a processor, and a computer program that is stored in the memory and that is capable of being run on the processor, wherein when executing the computer program, the processor implements steps of the method according to claim 1.
